(19) United States
(12) Patent Application Publication
(10) Pub. No.: US 2010/0169152 A1
(43) Pub. Date: Jul. 1, 2010

(54) Streaming advertisements to a computer platform in a secure and targeted manner

(76) Inventors: Moshe Maor, Kiryat Mozkin (IL); Gidi Etzion, Jerusalem (IL); Christopher E. Cukor, Berkeley, CA (US)

Correspondence Address: INTEL CORPORATION;c/o CPA Global, P.O. BOX 52050, MINNEAPOLIS, MN, 55402, US

(21) Appl. No.: 12/319,098

(22) Filed: Dec. 30, 2008

(51) Int. Cl. G06Q 30/00

(52) U.S. Cl. 705/10; 705/14.58

(57) ABSTRACT

In some embodiments targeted messaging and ads are delivered to a target customer in response to end user demographic information and end user computing platform behavior. The delivering is prevented from being overridden by a user or by any software running on the computing platform. Other embodiments are described and claimed.

### TECHNICAL FIELD

The inventions generally relate to streaming advertisements to a computer platform in a secure and targeted manner.

### BACKGROUND

There is currently not a way to implement advertising to a computing platform using streaming, storage, and/or display in a robust manner. Existing solutions are software-based and may be compromised, removed, hacked, etc. These software solutions are mostly web based and use streaming technologies (for example, see NebuAD at www.nebuad.com). Due to this inherent vulnerability, it is not possible to ensure ad impressions and click through rates (CTRs), or to robustly collect data to ensure targeted ad streaming

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

### DETAILED DESCRIPTION

Some embodiments of the inventions relate to streaming advertisements to a computer platform in a secure manner.

In some embodiments targeted messaging and ads are delivered to a target customer in response to end user demographic information and end user computing platform behavior. The delivering is prevented from being overridden by a user or by any software running on the computing platform.

In some embodiments targeted messaging and ads are received at a computing platform of a target customer that is targeted in response to end user demographic information and end user computing platform behavior. The targeted messaging and ads are prevented from being overridden by a user or by any software running on the computing platform.

In some embodiments a controller receives targeted messaging and ads at a computing platform of a target customer that is targeted in response to end user demographic information and end user computing platform behavior. The controller prevents the received targeted messaging and ads from being overridden by a user or by any software running on the computing platform.

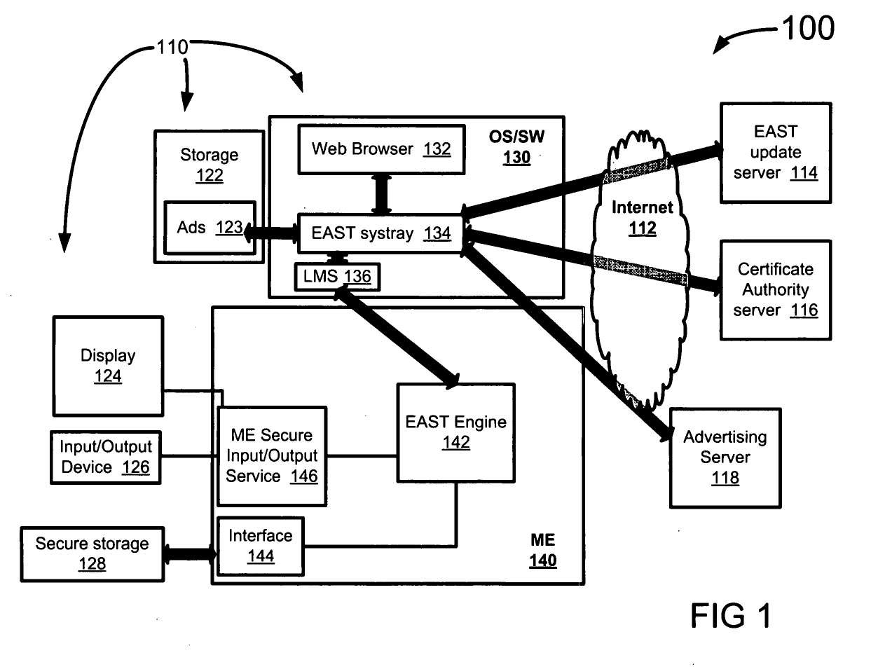

FIG. 1 illustrates a system 100 according to some embodiments. In some embodiments system 100 includes a computing platform 110, the internet 112, an Embedded Advertisement Streaming Technology (EAST) update server 114, a Certificate Authority (CA) server 116, and an advertising company (AdCo) server 118. In some embodiments, computing platform 110 is any computing platform (for example, a desktop, a notebook, a handheld, and/or any other type of computing platform). In some embodiments, computing platform 110 includes a local storage 122 (for example, a local hard disk drive) including a repository 123. In some embodiments, computing platform 110 additionally includes a display device 124, an Input/Output device 126 (for example, a mouse and/or a keyboard), a secure storage 128 (for example, secured flash storage) storing EAST policies, an Operating System and/or software 130 (OS/SW) and/or a management engine (and/or manageability engine and/or ME) 140. In some embodiments, OS/SW 130 includes a web browser 132, an EAST systray application 134, and a Local Manageability Service (LMS) 136. In some embodiments, LMS 136 is a software service running on the host OS that allows communication between software and ME 140. In some embodiments, ME 140 includes an EAST engine 142, an interface 144 (for example, a non-volatile memory interface), and an ME secure Input/Output service 146.

In some embodiments, the ads repository 123, the EAST systray application 134, and the EAST engine 142 are considered to be EAST components. In some embodiments, LMS 136, interface 144, and secure storage 128 are considered to be ME components. In some embodiments, ME secure input/output service 146 is considered to be a secure 10 component. In some embodiments, web browser 132 is considered to be an OS component.

In some embodiments the Embedded Advertisement Streaming Technology (EAST) is used to stream, store, and display advertisements on a computing platform such as computing platform 110 (for example, a personal computer). EAST can be used by advertisers to deliver targeted messaging and ads to their target customers based on end user demographic information as well as end user computing platform usage behavior. The EAST mechanism cannot be overridden by the user or by any software running on the computing platform 110. This level of tamper resistance combined with detailed demographic and computing platform usage data helps advertisers achieve higher click through rates (CTRs) than can be expected with traditional web based search or other software based targeting methods. This helps to transform a standard computing platform 110 (such as a desktop, notebook, handheld, etc.) into a powerful advertising platform.

EAST can be used by computer manufacturers and others to use EAST to generate recurring revenue streams by allowing the user to purchase a very inexpensive computer. The computer costs may be subsidized by companies that utilize the computing platform to advertise their products and services. Recurring revenues may be derived from continued use of the computing platform as a medium to display highly targeted advertisements.

In some embodiments, EAST update server 114 is a server of a company (for example, Intel Corporation) that can upgrade EAST components and data by sending signed updates to the EAST firmware engine 142. In some embodiments, certificate authority server 116 uses a certificate authority (CA) to validate the authenticity of the advertising server 118. Only specific allowed advertising company servers are allowed to interact with the EAST, based on, for example, business decisions of the company providing the EAST update server 114. In some embodiments, advertising server 118 is a server of an advertising company (AdCo) that has a contract with the company providing the EAST update server 114 to stream ads to select platforms of the company providing the EAST update server 114. The server 118 is used, for example, to read user statistics and send new ads to a user of the computing platform 110. In some embodiments, a software package (EAST kit) is integrated into advertising server 118. This software package is for example, developed by the company providing the EAST update server 114 and the computing platform 110 as part of the EAST technology. The software package (or kit) allows advertising server 118 to interact with deployed EAST devices for purposes of statistics collection and to send ads, for example.

In some embodiments, storage 122 is a local platform hard disk drive used as an EAST storage facility. The EAST engine 142 is used to securely store (for example, encrypted, integrity protected) in storage 122 EAST data locally (for example, on the computing platform 110 HDD in a hidden partition that is not used by the system OS). In some embodiments, secure storage 128 is a secured flash storage storing EAST policies. EAST uses secure storage 128 (for example, the platform flash device) to store initial configuration, ads, and other information, allowing EAST to “operate out of the box”. The secure storage 128 is also used to store information on sprite user click in a secure manner (that is, without software intervention). This prevents click fraud, thereby increasing the value of the data that is reported back to the advertiser and reducing ad spend on false clicks. EAST systray application 134 is a software application that runs within the regular OS context on an EAST platform. Application 134 is used to pave the communication path between EAST firmware and the different servers on the internet that act with EAST (for example, the advertising server 118).

In some embodiments, ME 140 is a micro-controller and/or an embedded controller. In some embodiments, ME 140 is included in a chipset of computing platform 110. In some embodiments, ME 140 is included in a Memory Controller Hub (MCH) of computing platform 110. In some embodiments, ME 140 is included in a Graphics and Memory Controller Hub of computing platform 110. In some embodiments, ME 140 is integrated into a processor, a Central Processing Unit (CPU), and/or a Graphics Processing Unit (GPU) of computing platform 110.

In some embodiments, ME 140 may be implemented using an embedded controller that is a silicon-resident management mechanism for remote discovery, healing, and protection of computer systems. In some embodiments, this controller is used to provide the basis for software solutions to address key manageability issues, improving the efficiency of remote management and asset inventory functionality in third-party management software, safeguarding functionality of critical agents from operating system (OS) failure, power loss, and intentional or inadvertent client removal, for example. In some embodiments, infrastructure supports the creation of setup and configuration interfaces for management applications, as well as network, security, and storage administration. The platform provides encryption support by means of Transport Layer Security (TLS), as well as robust authentication support.

In some embodiments the ME 140 is hardware architecture resident in firmware. A micro-controller within a chipset graphics and memory controller hubs houses Management Engine (ME) firmware, which implements various services on behalf of management applications. Locally, the ME can monitor activity such as the heartbeat of a local management agent and automatically take remediation action. Remotely, the external systems can communicate with the ME hardware to perform diagnosis and recovery actions such as installing, loading or restarting agents, diagnostic programs, drivers, and even operating systems.

Secure Input/Output technology included in system 100 can be used to completely mitigate any attempted attacks from keyloggers and other types of malware. In some embodiments, ME 140 included within computing platform 110 takes control over the input device 126 of the computing platform and sets up a trusted path between the user and the ME 140 via any input devices of computing platform 110 (such as a keyboard). Additionally, the ME 140 sets up a secured path (although not a direct connection) between the ME 140 and a remote server.

When funneling the sensitive data via the ME 140, the ME 140 actually encrypts the sensitive data that the user types, for example, before the software running on computing platform 110 obtains the data (for example, sensitive data such as credit card numbers, phone numbers, full name, addresses, etc.) In this manner, when the software that runs on the host processor, for example, of computing platform 110 is handling the data it is already encrypted and is therefore not usable for keyloggers in an attempt to steal the data. Therefore, the sensitive data of the user is kept secret when Secure input/output operations (for example, via ME140) are being used while the user is typing the data.

It is recognized that a management engine such as ME 140 is not necessary for all embodiments, and that other devices may be used to implement the same types of operations as described herein. Additionally, an Intel branded ME and/or Intel AMT is not necessary for all embodiments, and other devices may be used to implement the same types of operations as described herein.

In some embodiments, ME 140 is an embedded controller. In some embodiments, ME 140 is a manageability engine that is integrated into the chipset, CPU, and/or GPU. The ME runs the EAST engine firmware 142. East engine firmware 142 is firmware code that implements the EAST technology according to some embodiments. ME secure Input/Output service is a set of capabilities that enable ME firmware applications to directly interact with the user by showing a sprite on the user monitor 124 and receiving his input (for example, via a keyboard and/or a mouse) attached to the computing platform 110.

In some embodiments the Embedded Advertisement Streaming Technology (EAST) is used to stream, store, and display advertisements on a computing platform such as computing platform 110 (for example, a personal computer). EAST can be used by advertisers to deliver targeted messaging and ads to their target customers based on end user demographic information as well as end user computing platform usage behavior. The EAST mechanism cannot be overridden by the user or by any software running on the computing platform 110. This level of tamper resistance combined with detailed demographic and computing platform usage data helps advertisers achieve higher click through rates (CTRs) than can be expected with traditional web based search or other software based targeting methods. This helps to transform a standard computing platform 110 (such as a desktop, notebook, handheld, etc.) into a powerful advertising platform.

EAST can be used by computer manufacturers and others to generate recurring revenue streams by allowing the user to purchase a very inexpensive computer. The computer costs may be subsidized by companies that utilize the computing platform to advertise their products and services. Recurring revenues may be derived from continued use of the computing platform as a medium to display highly targeted advertisements.

In some embodiments, a default policy is hard-coded into the secure storage 128 when the EAST computing platform 110 ships to the consumer. Updated policies are downloaded into the EAST firmware from EAST update server 114 and/or advertising server 118, for example. These policies configure a set of elements such as particular advertising servers 118 with which to interact, policies with regard to how often to pop up ads, and/or statistics to collect, etc.

In some embodiments, the advertising server 118 sends via the EAST systray application 134 a signed blob of ads and ad configurations (e.g., optional configuration/policy per ad), for example, that are rooted to root-cert in the secure storage 128. EAST user statistics are also sent to the advertising server 118 in order to allow the advertising company to choose and tune the ads to the taste of the user. EAST encrypts the ads and statistics and stores them in the ad repository 123 of the storage 122 via the EAST software agent 134.

In some embodiments, pop up ads are managed per configuration using the ME Secure 10 service 146. East also collects data from the user per user clicks and buttons inside the sprite (for example, “close”, “open in browser”, etc.) When the user clicks “open in browser”, for example, the EAST firmware 142 uses the EAST software agent 134 to launch the installed web browser 132 and open the URL that is attached to the ad that is currently shown.

In some embodiments, advertisement streaming, storage, and display is implemented in a robust manner. Since existing solutions are software-based, they may be compromised, removed, hacked, etc. Due to this inherent vulnerability, it is not possible to ensure ad impressions and click through rates (CTRs). Delivering impressions and higher than average CTRs are core to the business proposition of delivering a low cost personal computer and generating a recurring revenue. Hardware based sprite technology may be used to “ensure good user behavior” as ads will continue to pop up even if the user or other software attempts to interfere with the EAST technology. EAST allows a company to work with Original Equipment Manufacturers (OEMs), advertising companies, and service providers to provide free or ultra-low priced computing platforms to consumers. Recurring revenue comes from advertisers using the advertising company to stream ads into the computing platform in a secure, robust manner. In some embodiments, a hardened solution is used to stream ads from advertisers (through an advertising company) to a user's monitor in a robust way. Thanks to the secured nature of Secure 10 implementations, statistics (for example, user clicks) are very accurate and not susceptible to fraud, which is very common using other ad streaming techniques. Therefore, EAST allows advertising companies such as Google, Yahoo, and MSN to charge a higher cost per click (CPC) due to the captive audience that can be reached. OEMs and service providers also want to participate in using this technology in order to participate in a recurring revenue stream and to capture new customers. Advertisers find this technology beneficial because they are able to acquire new customers through better targeted advertising due to the accurate and fraud-resistant statistics.

It is noted that although in some embodiments some data on personal behavior is gathered (for example, in a targeted manner), the secure and/or hardened engine that is used to implement some embodiments is unbreakable, and the user's privacy is maintained.

Although some embodiments have been described herein as being implemented in a particular manner, according to some embodiments these particular implementations may not be required. For example, ME technology is not required in some embodiments. Similarly, an LMS service is not required in some embodiments. Additionally, it is noted that some embodiments may be implemented that do not include both secure input and secure output. For example, in some embodiments, EAST may be delivered on a system that has secure output but does not have secure input. Additionally, it is noted that in some embodiments EAST and/or secure I/O may be implemented in a chipset, a Central Processing Unit, or a Graphics Processing Unit of the computing platform 110, for example. In some embodiments, EAST and/or secure I/O are not implemented in software, but may be implemented in a parallel execution environment that is powered by the cores of the main CPU and/or GPU.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method comprising:
delivering targeted messaging and ads to a target customer in response to end user demographic information and end user computing platform behavior; and
preventing the delivering from being overridden by a user or by any software running on the computing platform.

2. The method of claim 1, further comprising providing a secure communication path with an update server, a certificate authority server, and an advertising server.

3. The method of claim 1, further comprising securely storing ad information and user click information without software intervention.

4. The method of claim 1, further comprising allowing interaction only with specific advertisement servers.

5. The method of claim 1, further comprising upgrading the delivering and/or preventing using signed updates.

6. The method of claim 1, further comprising securely providing the end user computing platform behavior to an advertising server.

7. The method of claim 1, further comprising preserving the accuracy of the end user computing platform behavior.

8. A method comprising:
receiving targeted messaging and ads at a computing platform of a target customer that is targeted in response to end user demographic information and end user computing platform behavior; and
preventing the targeted messaging and ads from being overridden by a user or by any software running on the computing platform.

9. The method of claim 8, further comprising providing a secure communication path with an update server, a certificate authority server, and an advertising server.

10. The method of claim 8, further comprising securely storing ad information and user click information without software intervention.

11. The method of claim 8, further comprising allowing interaction only with specific advertisement servers.

12. The method of claim 8, further comprising upgrading the delivering and/or preventing using signed updates.

13. The method of claim 8, further comprising securely providing the end user computing platform behavior to an advertising server.

14. The method of claim 8, further comprising preserving the accuracy of the end user computing platform behavior.

15. An apparatus comprising:
a controller to receive targeted messaging and ads at a computing platform of a target customer that is targeted in response to end user demographic information and end user computing platform behavior, and to prevent the received targeted messaging and ads from being overridden by a user or by any software running on the computing platform.

16. The apparatus of claim 15, the controller further to provide a secure communication path with an update server, a certificate authority server, and an advertising server.

17. The apparatus of claim 15, further comprising a secure storage to securely storing ad information and user click information without software intervention.

18. The apparatus of claim 15, the controller further to allow interaction only with specific advertisement servers.

19. The apparatus of claim 15, the controller further to upgrade the targeted messaging and ads using signed updates.

20. The apparatus of claim 15, the controller further to securely provide the end user computing platform behavior to an advertising server.

21. The apparatus of claim 15, the controller further to preserve the accuracy of the end user computing platform behavior.
